(19) United States
(12) Patent Application Publication
(10) Pub. No.: US 2006/0133600 A1
(43) Pub. Date: Jun. 22, 2006

(54) Flexible hybrid structure tunable for different telecom market solutions

(75) Inventor: Wayne T. Holcombe, Mountain View, CA (US)

Correspondence Address: FRANCISSEN PATENT LAW, P.C., 53 W. JACKSON, SUITE # 656, CHICAGO, IL, 60604, US

(73) Assignee: Integration Associates Inc., Mountain View, CA (US)

(21) Appl. No.: 11/291,717

(22) Filed: Dec. 1, 2005

Related U.S. Application Data
(60) Provisional application No. 60/633,051, filed on Dec. 3, 2004.
(60) Provisional application No. 60/633,478, filed on Dec. 6, 2004.

(51) Int. Cl. H04M 9/08

(52) U.S. Cl. 379/406.08

(57) ABSTRACT

A hybrid circuit for use with a transformer includes a differential transmit amplifier having first and second input terminals for receiving a signal to be transmitted and a pair of output terminals that may be coupled to the transformer. The hybrid circuit also includes a summing node receive amplifier having an input terminal that may be coupled to the transformer and an output terminal that is accessible external to the hybrid circuit. The differential transformer provides for improved transmit amplitude when a low supply voltage is used. The externally accessible output of the summing node receive amplifier provides for adjustment of the receive gain to improve dynamic range and for tuning of the hybrid for different circuit requirements.

### CROSS REFERENCE TO RELATED APPLICATIONS

This application claims priority to U.S. Provisional Patent Application No. 60/633,051 filed Dec. 3, 2004, entitled FLEXIBLE HYBRID STRUCTURE TUNABLE FOR DIFFERENT TELECOM MARKET SOLUTIONS, herein incorporated by reference in its entirety. This application also claims priority to U.S. Provisional Patent Application No. 60/633,478 filed Dec. 6, 2004, entitled TELEPHONE INTERFACE CIRCUITRY, herein incorporated by reference in its entirety.

### BACKGROUND

In transformer based data access arrangement (DAA) circuits, a hybrid function is typically provided that generally provides impedance matching for the telephone line, separates the incoming and outgoing signals, and, often, provides a sidetone or feedback signal from the transmit path to the receive path. The hybrid function is typically performed on the line side by circuitry containing two or more amplifier circuits. Because different countries or regions have different telecommunication standards and requirements, the hybrid circuits for each of these telecom markets generally have different specifications that require different components and circuits.

### SUMMARY OF THE INVENTION

An embodiment of a hybrid circuit for use with a transformer includes a differential transmit amplifier having first and second input terminals for receiving a signal to be transmitted and a pair of output terminals that may be coupled to the transformer. The hybrid circuit also includes a summing node receive amplifier having an input terminal that may be coupled to the transformer and an output terminal that is accessible external to the hybrid circuit. The differential transformer provides for improved transmit amplitude when a low supply voltage is used. The externally accessible output of the summing node receive amplifier provides for adjustment of the receive gain to improve dynamic range and for tuning of the hybrid for different circuit requirements.

### BRIEF DESCRIPTION OF THE DRAWINGS

Certain embodiments are described below with reference to the following drawings, wherein:

FIG. 1 is a functional block diagram of an embodiment of a DAA and a circuit that includes a hybrid function;

FIG. 2 is a simplified circuit diagram illustrating one example of the components in the DAA of FIG. 1 and their interconnection with hybrid circuitry; and

FIG. 3 is a simplified circuit diagram illustrating another example of the components in the DAA of FIG. 1 and their interconnection with hybrid circuitry.

### DETAILED DESCRIPTION OF EMBODIMENT

In one embodiment, a pair of amplifiers are integrated in a modem analog front end integrated circuit (IC). This approach allows the number of components on the modem circuit to be reduced, but does not reduce the need for flexibility in the design in order to accommodate different telecommunication requirements.

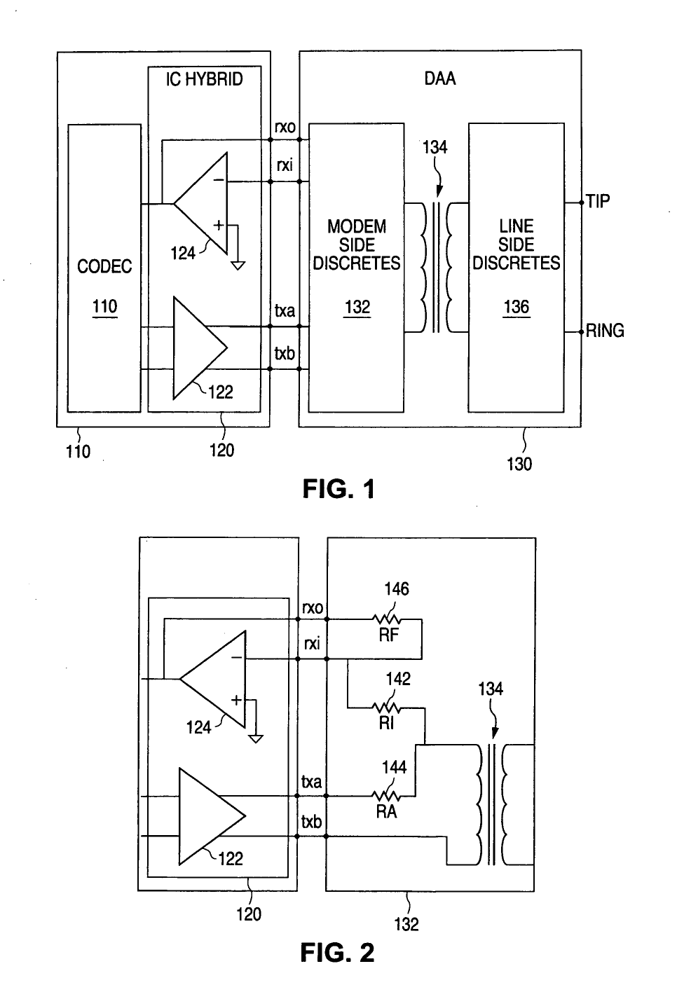

FIG. 1 is a functional block diagram of an embodiment of a DAA 130 and a modem side circuit 100 that includes a circuit 120 that performs a hybrid function. Hybrid circuit 120 may be integrated on the same die as other modem side circuitry, such as codec 120, or may be a separate integrated circuit that is part of the modem side circuit 100. As illustrated in FIG. 1, the transmit section 122 of the hybrid 120 is differential, but the receive section 124 is single ended. The differential outputs of transmit amplifier 122 are coupled to external interface pins txa and txb. A differential amplifier 122 is used on the transmit side because the transmit section is generally required to operate using a low supply voltage. As a result, in order to transmit the necessary signal power onto the telephone line TIP and RING pair, the transformer 134 that interfaces to the line pair is generally driven differentially. On the receive side, power is typically not an issue because the received signal has an amplitude that is much lower than the signal that must be transmitted.

The single ended receive amplifier 124, contrary to its transmit counterpart, has external feedback and input resistors that are connected to the amplifier 124 via external interface pins rxo and rxi. The present approach enables the tuning of the gain of the receive amplifier 124 to be determined externally by leaving the output of the receive amplifier (rxo) available to a designer who is tuning the DAA to verify the signal amplitude and quality.

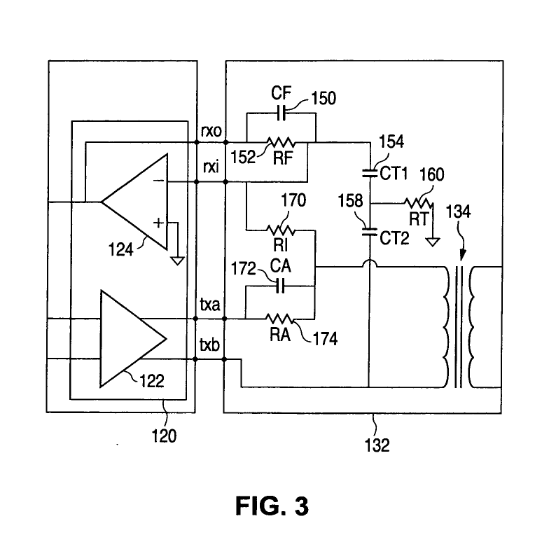

With this configuration of the hybrid amplifiers available in the IC, the full hybrid can be adjusted to accommodate the design requirements of multiple telecommunication markets. Two examples of how the complete hybrid can be implemented are shown in FIGS. 2 and 3 to illustrate the flexibility of the hybrid structure design.

The example shown in FIG. 2 is a relatively simple hybrid arrangement using only three external components: resistors 146, 142 and 144 having resistance values RF, RI and RA, respectively. Resistor 144 (RA) is a transmit impedance adaptation resistor that is used to match the modem side impedance on the primary winding of the transformer 134, with the line side impedance on the secondary winding of the transformer. Its value is dependent on the transformer resistive component and on the line side impedance. Resistor 142 (RI) is the input resistance of the Receive hybrid structure and resistor 146 (RF) the feedback resistor. Their values determine the receive gain and, by placing these modem side discretes 132 outside of the IC hybrid 120, they can be changed to accommodate different line and signal conditions.

The circuit shown in FIG. 3 illustrates an example of the flexibility of the present design. In this figure, an arrangement for the modem side discretes 132 is shown that is directed toward long lines that need a complex domain impedance termination. This is achieved, in this example, by adding capacitor 172 (CA) in parallel with the transmit adapting resistor 174 (RA), to adapt to the complex impedance of transformer 134, and the use of a resistive/capacitive (RC) network involving capacitors 154 (CT1) and 158 (CT2) along with resistor 160 (RT) to provide a complex termination impedance for the telephone line pair. Two capacitors 154 and 158 are provided to couple to both differential transmit outputs of transmit amplifier 122. The terminating impedance can thus be matched to the complex line impedance of the telephone line pair.

In the example of FIG. 3, feedback circuit capacitor 150 (CF) is used with resistor 152 (RF) in the receive hybrid stage involving receive amplifier 124 to create an input anti-aliasing filter. If needed, higher order filters can also be implemented, e.g. a Sallen-Key biquad.

As an example of other features that can be added to the example of FIG. 2, if a transmit to receive echo is a problem for a given implementation, then the echo can be attenuated by using an extra resistor between terminals txb and rxi.

The hybrid structure shown provides for flexible hybrid design in order to adapt a transformer hybrid structure to the different requirements for different telecom markets. The differential transmit driver permits the circuit to operate at lower voltage levels, which is important for applications that operate, for example, on 3.3V voltage supplies.

The receive amplifier 124 in the hybrid circuit is a summing node input amplifier. Typically, for telephony audio, the maximum transmit audio needs to exceed +3 dBM (600 ohm) sine wave or 1.1V peak or 2.2VPP. For example, when driving from a 600 ohm source, the driver typically needs to be at twice this level, e.g. 4.4VPP, due to the 6 dB attenuation of the line load. A single ended transmit driver cannot achieve this level when operating on 3.3V, but this level can be achieved by a differential driver operating on 3.3V. The receiver amplifier with both summing node inverting input and an externally available output permits the receive gain to be adjusted to improve the dynamic range and is flexible for hybrid tuning. For example, a complex line impedance can be cancelled by selecting. e.g. tuning, the appropriate RC networks between the inverting summing node and the two transmit differential drivers from transmit amplifier 122.

Also, the summing node amplifier 124 permits echo cancellation to be performed with the differential outputs of the transmit amplifier 122. Echo cancellation is performed by inverting the transmit signal and combining it with the reflected transmit signal returned from transformer 134. While the input of receive amplifier 124 amplifies a received signal with respect to a ground potential, the outputs of transmit amplifier 122 differentially drive a transmit signal with regard to one another. Consequently, the differential output signal must be summed for purposes of echo cancellation on the receive side. The use of a summing node amplifier on the receive side permits the differential output from transmit amplifier 122 to be summed and inverted so that it may be used to cancel out the echo received from the transformer 134.

The present circuit may be combined with the circuits described in the following commonly owned patent applications filed Dec. 3, 2004, herein incorporated by reference in their entirety: U.S. Patent Application No. 60/633,389 for Flexible Hook Switch Driver Circuit, and its corresponding utility application U.S. patent application Ser. No. ______; U.S. Patent Application No. 60/632,910 for Multiplexed Voltage Reference Strategy for Codec and its corresponding utility application U.S. patent application Ser. No. ______; and U.S. Patent Application No. 60/632,839 for Ring Detect and Snoop Circuit and its corresponding utility application U.S. patent application Ser. No. ______.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

We claim:

1. A hybrid circuit for use with a transformer, the circuit comprising:
an integrated circuit having first, second, third and fourth external interface pins;
a summing node receive amplifier having a first input terminal coupled to the first external interface pin, a second input terminal coupled to a power supply source, and an output coupled to the second external interface pin, such that the summing node receive amplifier may be coupled to the transformer and a gain and impedance of the summing node receive amplifier may be determined using external components;
a differential transmit amplifier having first and second input terminals for receiving a signal to be transmitted, a first output terminal coupled to the third external interface pin, and a second output terminal coupled to the fourth external interface pin, such that the differential transmit amplifier may be coupled to the transformer and to the receive amplifier.

2. The circuit of claim 1, the circuit further comprising:
a first external resistor electrically coupled between a first terminal of the transformer and the first external interface pin (rxi);
a second external resistor electrically coupled between a second terminal of the transformer and the second external interface pin (rxo);
a third external resistor electrically coupled between the first terminal of the transformer and the third external interface pin (txa); and
a conductor electrically coupled between the second terminal of the transformer and the fourth external interface pin (txb).

3. The circuit of claim 2, the circuit further comprising:
a first external capacitor coupled between the second terminal of the transformer and the second external interface pin in parallel with the second external resistor to form an anti-aliasing filter.

4. The circuit of claim 3, the circuit further comprising a second external capacitor electrically coupled between the first terminal of the transformer and the third external interface pin.

5. The circuit of claim 4, the circuit further comprising:
a fourth external resistor electrically coupled to a power supply terminal;
a third external capacitor electrically coupled between the fourth external resistor and the first external interface pin; and
a fourth external capacitor electrically coupled between the fourth external resistor and the fourth external interface pin.

6. A method for providing a hybrid circuit for use with a transformer, the method comprising the steps of:
fabricating a summing node receive amplifier in an integrated circuit, where the summing node receiver has an input terminal and an output terminal accessible external to the integrated circuit;
fabricating a differential transmit amplifier in the integrated circuit, where the transmit amplifier has first and second output terminals that are accessible external to the integrated circuit;
coupling the summing node receive amplifier and differential transmit amplifier to the transformer using external discrete circuit elements.

7. The method of claim 6, where the step of coupling the summing node receive amplifier and differential transmit amplifier to the transformer using external discrete circuit elements further comprises:
determining a gain and impedance of the summing node receive amplifier using the external discrete circuit elements.

8. The method of claim 6, where the step of coupling the summing node receive amplifier and differential transmit amplifier to the transformer using external discrete circuit elements further comprises:
attenuating a transmit to receive echo using the external discrete circuit elements.

9. The method of claim 6, where the step of coupling the summing node receive amplifier and differential transmit amplifier to the transformer using external discrete circuit elements further comprises:
matching a complex line impedance using external discrete circuit elements coupled between the summing node receive amplifier and the transmit amplifier.

10. The method of claim 6, where the step of coupling the summing node receive amplifier and differential transmit amplifier to the transformer using external discrete circuit elements further comprises:
providing a complex domain impedance termination for a telephone line pair coupled to the transformer using the external discrete circuit elements.
